(19) United States
(12) Patent Application Publication
(10) Pub. No.: US 2005/0107982 A1
(43) Pub. Date: May 19, 2005

(54) Method and system for noise estimation from video sequence

(76) Inventors: Zhaohui Sun, Rochester, NY (US); Gabriel Fielding, Webster, NY (US); Majid Rabbani, Pittsford, NY (US)

Correspondence Address: Pamela R. Crocker;Patent Legal Staff, Eastman Kodak Company, 343 State Street, Rochester, NY, 14650-2201, US

(21) Appl. No.: 10/715,276

(22) Filed: Nov. 17, 2003

(51) Int. Cl. G06F 15/00

(52) U.S. Cl. 702/179

(57) ABSTRACT

A method for determining the noise level, as characterized by the standard deviation, of an input video sequence corrupted by unknown noise comprises the steps of: (a) spatiotemporally filtering the input video sequence, thereby producing a filtered video sequence; (b) estimating a standard deviation from the difference between the input video sequence and the filtered video sequence, thereby producing an estimated standard deviation; and (c) iterating through steps (a) and (b) using the estimated standard deviation previously obtained from step (b) to perform the filtering in step (a) until the value of the noise level approaches the unknown noise, whereby the noise level is then characterized by a finally determined standard deviation.

### FIELD OF THE INVENTION

The invention relates generally to the field of digital video and image sequence processing, and in particular to noise estimation from a noisy video sequence.

### BACKGROUND OF THE INVENTION

In recent years, as video capture, storage, transmission, display, manipulation, and management become easier and cheaper, video is getting widespread use in communication, entertainment, education, security, surveillance, medicine, and military applications. However, there is always a certain level of noise captured in a video sequence, such as electronic noise, photon noise, film grain noise, and quantization noise. The noise contaminates visual quality and makes the content less useful. For example, noise makes it difficult to analyze the crime scene in a surveillance video. Noise also increases entropy and decreases coding efficiency, so it takes more storage space and wider transmission bandwidth to communicate and record video. It also makes content description less discriminative and content management less effective. Therefore, it is desirable to estimate and reduce the noise while preserving video content. To effectively reduce noise, good knowledge of the noise characteristics is needed, so appropriate algorithms and parameters can be chosen for the specific dataset.

After years of effort, noise estimation from video sequences still remains a challenging task. Most of the time, the degraded video is the only observation available. Inter-frame intensity differences observed in the degraded video are partly due to scene/object motion and partly due to noise. Estimation of the noise requires tremendous computational power because of the amount of data involved in a video sequence. Furthermore, noise estimation is used in conjunction with noise reduction, and the estimation becomes more reliable if the filtered video is closer to the noise-free groundtruth.

Research on noise estimation and reduction in video sequences has been going on for decades. “Noise reduction in image sequence using motion-compensated temporal filtering” by E. Dubois and M. Sabri, IEEE Trans. on Communication, 32(7):826-831, 1984, presented one of the earliest schemes using motion for noise reduction. A comprehensive review of various methods is available in “Noise reduction filters for dynamic image sequence: a review” by J. C. Brailean, et al., Proceedings of the IEEE, 83(9):1272-1292, September 1995.

Commonly-assigned, copending U.S. patent application Ser. No. 10/602,427 filed 24 Jun. 2003, entitled “System and method for estimating, synthesizing, and matching noise in digital images and image sequences” by G. Fielding, discloses methods to synthesize noise, match noise in two images, and automatically compute noise statistics in an image sequence. Commonly-assigned U.S. Pat. No. 5,923,775, “Apparatus and method for signal dependent noise estimation and reduction in digital images” to P. Snyder et al., discloses a method to estimate signal (code value) dependant noise in an image and subsequently to reduce that noise. The estimation is carried out on a single image. U.S. Pat. No. 5,764,307, “Method and apparatus for spatially adaptive filtering for video encoding” to T. Ozcelik et al., discloses a noise estimation method based on a displaced frame difference to facilitate video coding and compression. The estimated noise level is the difference between a video frame and a motion compensated frame after block-matching motion estimation. Noise estimation is carried out on a single frame. Published European Patent Application EP0957367, “Method for estimating the noise level in a video sequence” to F. Le Clerc, discloses a method for noise estimation by combining the analysis of displaced field or frame differences (DFD) and the values of the field or frame differences (FD) over static picture areas. Published European Patent Application EP 1126729, “A process for estimating the noise level in sequences of images and a device therefore” to A. Borneo et al., discloses a process to estimate noise level in an image sequence.

The previously disclosed approaches estimate noise on a 2-D spatial domain or on a 3-D spatiotemporal domain in an open-loop fashion. The computations are carried out in a batch mode without iterations. Moreover, the estimated noise level was not used to improve motion estimation and spatiotemporal filtering, which heavily depend on the knowledge of the error characteristics in video. Furthermore, robust methods were not used for noise estimation in these approaches. Robust methods become crucial when noise is presented, as they can alleviate the sensitivity of occasional model violations.

What is needed is a robust noise estimation method for a noise-corrupted video sequence, with decreased sensitivity to model violations and outliers.

### SUMMARY OF THE INVENTION

The object of the invention is to provide a robust noise estimation method for a noisy video sequence.

The present invention is directed to overcoming one or more of the problems set forth above. Briefly summarized, according to one aspect of the present invention, the invention resides in a method for determining the noise level, as characterized by the standard deviation, of an input video sequence corrupted by unknown noise, comprising the steps of: (a) spatiotemporally filtering the input video sequence, thereby producing a filtered video sequence; (b) estimating a standard deviation from the difference between the input video sequence and the filtered video sequence, thereby producing an estimated standard deviation; and (c) iterating through steps (a) and (b) using the estimated standard deviation previously obtained from step (b) to perform the filtering in step (a) until the value of the noise level approaches the unknown noise, whereby the noise level is then characterized by a finally determined standard deviation.

The advantages of the disclosed method include: (a) estimating the noise level from the noisy video and the filtered video, without the availability of the noise-free video; (b) carrying out the estimation process in a closed loop to iteratively improve noise estimation and spatiotemporal filtering successively; (c) employing a robust method to alleviate the sensitivity of occasional model violation and outliers; and (d) using a fast median sorting scheme for efficient computation.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 generally illustrates features of a system in accordance with the present invention.

FIG. 2 shows a system diagram of noise estimation.

FIG. 3 shows a procedure to estimate a noise level from a noisy sequence.

FIG. 4 shows a fast median estimation procedure.

FIG. 5 shows a normalized histogram of εₙ (bars) and a fitted normal distribution (envelop).

### DETAILED DESCRIPTION OF THE INVENTION

In the following description, a preferred embodiment of the present invention will be described in terms that would ordinarily be implemented as a software program. Those skilled in the art will readily recognize that the equivalent of such software may also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, may be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

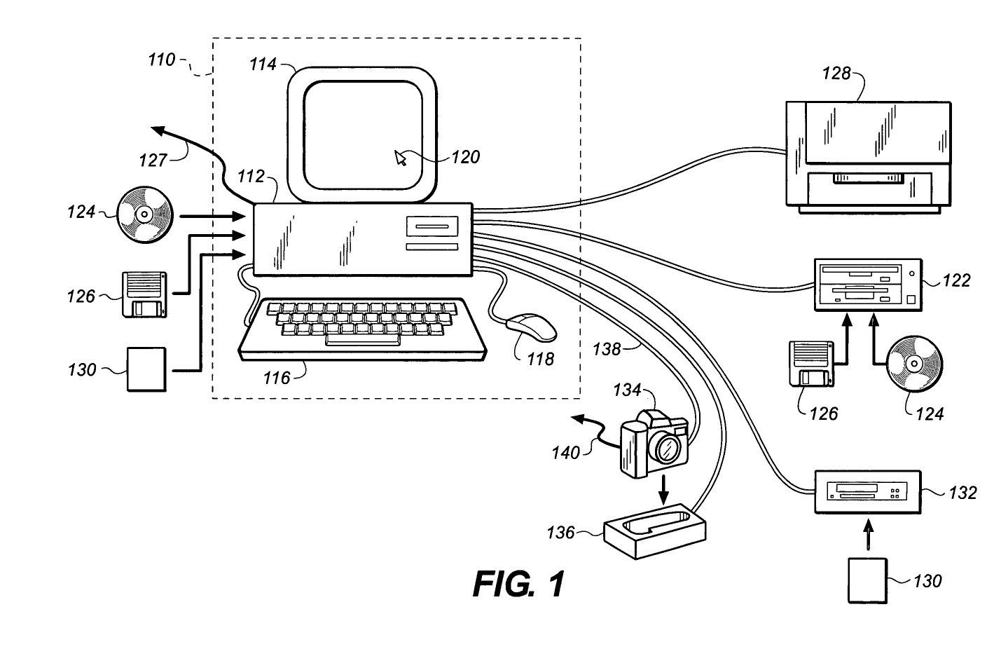

Before describing the present invention, it facilitates understanding to note that the present invention is preferably utilized on any well-known computer system, such as a personal computer. For instance, referring to FIG. 1, there is illustrated a computer system 110 for implementing the present invention. Although the computer system 110 is shown for the purpose of illustrating a preferred embodiment, the present invention is not limited to the computer system 110 shown, but may be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor-based unit for providing a means of inputting the software programs and other information to the microprocessor based unit 112. In addition, a floppy disk 126 may also include a software program, and is inserted into the microprocessor-based unit 112 for inputting the software program. The compact disk-read only memory (CD-ROM) 124 or the floppy disk 126 may alternatively be inserted into externally located disk drive unit 122 which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images and videos may also be displayed on the display 114 via a personal computer card (PC card) 130, such as, as it was formerly known, a PCMCIA card (based on the specifications of the Personal Computer Memory Card International Association) which contains digitized images electronically embodied in the card 130. The PC card 130 is ultimately inserted into the microprocessor-based unit 112 for permitting visual display of the image on the display 114. Alternatively, the PC card 130 can be inserted into an externally located PC card reader 132 connected to the microprocessor-based unit 112. Images may also be input via the compact disk 124, the floppy disk 126, or the network connection 127. Any images and videos stored in the PC card 130, the floppy disk 126 or the compact disk 124, or input through the network connection 127, may have been obtained from a variety of sources, such as a digital image or video capture device 134 or a scanner (not shown). Images or video sequences may also be input directly from a digital image or video capture device 134 via a camera or camcorder docking port 136 connected to the microprocessor-based unit 112 or directly from the digital image or video capture device 134 via a cable connection 138 to the microprocessor-based unit 112 or via a wireless connection 140 to the microprocessor-based unit 112.

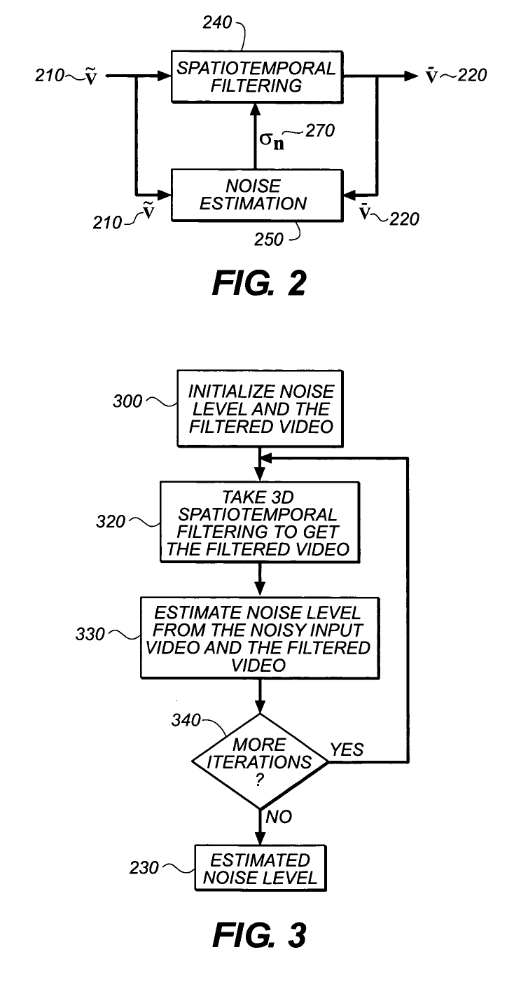

Referring now to FIG. 2, a system diagram employing robust noise estimation from a video sequence is illustrated. A digital video sequence V={I(i,j,k), i=1 . . . M, j=1 . . . N, k=1 . . . K} is a temporally varying 2-D spatial signal I on frame k, sampled and quantized at spatial location (i,j). The observed input video sequence \overline{V} 210 is corrupted by additive random noise \overline{V}=V+ε with ε following a Gaussian distribution N(0, σₙ). Given the additive degradation model
\overline{I}(i, j, k)=I(i, j, k)+ε(i, j, k)
with ε(i, j, k) as the independent noise term, the noise level 270, measured by the standard deviation, can be estimated from the noisy input video sequence \overline{V} and the noise-free video V, as follows:

$${σ}_{n}^{2} = \frac{1}{KMN} {\sum }_{k = 1}^{K} {\sum }_{m = 1}^{M} {\sum }_{n = 1}^{N} {( \tilde{I} ( i , j , k ) - I ( i , j , k ) )}^{2} .$$

As the groundtruth V is not available, we estimate the noise level σₙ 270 from the difference between the observed input video sequence \overline{V} and the filtered video sequence \overline{V} 220. A spatiotemporal filtering module 240 reduces the random noise in \overline{V} and generates the filtered video \overline{V}. Noise estimation module 250 takes both \overline{V} and \overline{V} as input and estimates the noise level, as characterized by the standard deviation σₙ 270. The process is iterated in a closed-loop fashion as shown in FIG. 2, which is necessary because σₙ estimated from \overline{V}-\overline{V} is in fact the noise reduction in one pass. The iterations successively improve the spatiotemporal filtering 240 and the noise estimation 250. As temporal correlation gets stronger from improved motion fields, it leads to better noise reduction in \overline{V}. As \overline{V} gets closer to V, it in turn increases the accuracy of the noise and motion estimation.

The procedure can be summarized in a flow chart in FIG. 3. Given the noisy video sequence, the output is the estimated noise level σₙ. First, the standard deviation σₙ and the filtered video \overline{V} are initialized in step 300. At a high signal to noise ratio (SNR), i.e. the noise level is relatively small compared to the signal, and the filtered video is initialized as the input video \overline{V}. At low signal to noise ratio (SNR), i.e., the image quality is poor, \overline{V} is initialized as the spatially filtered input video (without motion compensation). The video frames are spatiotemporally filtered by adaptive weighted averaging in step 320, yielding the filtered video \overline{V} (220). Motion compensation is helpful in step 320 to enhance temporal correlation. The noise level, as characterized by the standard deviation σₙ, is computed from the difference between the input noisy video \overline{V} and the filtered video \overline{V}. The estimated noise level in turn is used for improved spatiotemporal filtering 240, until the change in the estimated noise level is small enough, i.e., smaller than some predetermined threshold, or a predetermined number of iterations has been reached. At the end of the iterations, the estimated noise level is taken as the final result 230, i.e., as thus characterized by a final standard deviation σₙ.

In the following, we present more details for the noise estimation module 250 and the specific procedure 330. The structure of \overline{V}-\overline{V} is complicated, partly due to random noise, incorrect motion trajectories, and imperfect spatiotemporal filtering. Thus a robust method is used to estimate σₙ and to reduce the sensitivity of the occasional violations of the underlying model and assumptions. Model violations may be caused by scene changes, illumination changes, occlusions, and shadows, yielding incorrect motion vectors and imperfect noise filtering. Let the residue \overline{V}-\overline{V} be denoted as
εₙ={\overline{I}(i, j, k)−\overline{I}(i, j, k)|i=1 . . . M,j=1 . . . N,k=1 . . . K}
It is mainly due to the random noise, with occasional changes in the video structure as outliers. A robust estimate of the noise level is
σₙ=1.4826 median {|εₙ−median{εₙ}|}

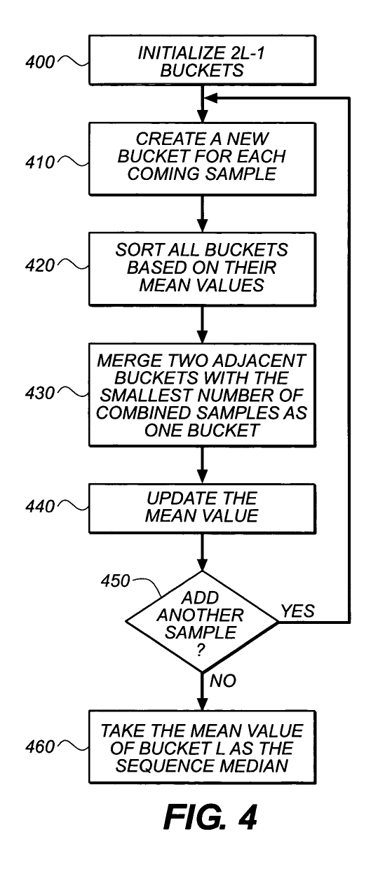

A fast (approximate) median sorting algorithm is used on the sampled subset of εₙ for efficient computation, because the size of εₙ is quite significant. The details of the median estimation algorithm are shown in FIG. 4. 2L-1 ordered buckets are maintained with roughly the same number of samples in each bucket, and the mean value of bucket L is used as an approximation of the sequence median. First, 2L- 1 buckets are initialized. Each bucket is characterized by its mean value (average) and size (the number of samples inside) in step 400. Samples are sequentially added to the ordered buckets. Each time, a new bucket is created in step 410 and sorted with the other buckets in step 420 based on the bucket mean values; the two adjacent buckets with the smallest number of samples are merged as one in 430; and the corresponding mean value is updated in 440. The termination condition is checked in 450 until there are no more unsorted samples left. At the end, the mean value of bucket L is taken as an approximate of the sequence median 460. This procedure can dramatically decrease sorting complexity and yield efficient computation.

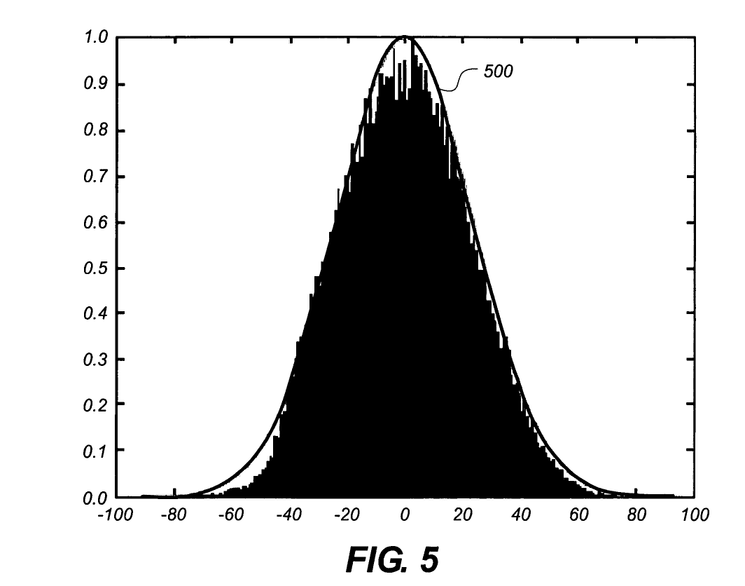

An example of the noise estimation is shown in FIG. 5. The bars show the normalized histogram of εₙ, i.e., the difference between the observed noisy video and the filtered video. The envelope 500 shows the fitted Gaussian model N(0, σₙ) by the robust method.

The estimated noise level can be used to reduce the random noise in a video sequence by spatiotemporal filtering. Numerous motion estimation algorithms, such as gradient-based, region-based, energy-based, and transform-based approaches, can be used to enhance the temporal correlation. There are also a number of filters available for spatiotemporal filtering, including Wiener filter, Sigma filter, median filter, and adaptive weighted average (AWA) filter.

Testing of this robust estimation method has been carried out for a video sequence degraded to various noise levels. After a few iterations, the estimated standard deviation σₙ gets very close to the groundtruth.

The invention has been described in detail with particular reference to a presently preferred embodiment, but it will be understood that variations and modifications can be effected within the spirit and scope of the invention.

### Parts List

110 Computer system
112 Microprocessor-based Unit
114 Display
116 Keyboard
118 Mouse input device
120 Selector on display
122 Disc drive unit
124 Compact disc-read only memory
126 Floppy disk
127 Network connection
128 Printer
130 PC card
132 PC card reader
134 Digital image or video capture device
136 Digital camera or camcorder docking port
138 Cable connection
140 Wireless connection
210 Input video sequence \overline{V}
220 Filtered video sequence \overline{V}
240 Spatiotemporal filtering module
250 Noise estimation module
270 Noise level
300 Initialization step
320 Spatiotemporal filtering step
330 Noise level estimation step
340 Termination condition checking step
400 Initialize 2L-1 buckets step
410 New bucket creation step
420 Sorting step
430 Adjacent bucket merging step
440 Mean value updating step
450 Termination condition checking step
460 Mean value step
500 Envelope

1. A method for determining the noise level; as characterized by the standard deviation, of an input video sequence corrupted by unknown noise, said method comprising the steps of:
(a) spatiotemporally filtering the input video sequence, thereby producing a filtered video sequence;
(b) estimating a standard deviation from the difference between the input video sequence and the filtered video sequence, thereby producing an estimated standard deviation; and
(c) iterating through steps (a) and (b) using the estimated standard deviation previously obtained from step (b) to perform the filtering in step (a) until the value of the noise level approaches the unknown noise of the input video sequence, whereby the noise level is then characterized by a finally determined standard deviation.

2. The method of claim 1 wherein the iterations in step (c) are carried out until the change in estimated noise level is less than a predetermined threshold.

3. The method of claim 1 wherein the iterations in step (c) are carried out until a predetermined number of iterations has been reached.

4. The method of claim 1 wherein step (a) employs motion estimation and compensation to establish temporal trajectories of moving points and enhance temporal correlation between points across frames.

5. The method of claim 1 wherein the spatiotemporal filtering of step (a) reduces random noise independent of video structure.

6. The method of claim 2 wherein a fast median estimation method is employed for efficient computation.

7. The method of claim 1 wherein the finally determined standard deviation corresponding to the noise level is used to reduce noise in the input video sequence through spatiotemporal filtering.

8. The method of claim 7 wherein the finally determined standard deviation corresponding to the noise level is used to evaluate video quality without using a reference video input corresponding to a ground truth value.

9. A computer storage medium having instructions stored therein for causing a computer to perform the method of claim 1.

10. System for determining the noise level, as characterized by the standard deviation, of an input video sequence corrupted by unknown noise, said system comprising:
a spatiotemporal filtering module for processing the input video sequence, thereby producing a filtered video sequence;
a noise estimation module for estimating a standard deviation from the difference between the input video sequence and the filtered video signal, thereby producing an estimated standard deviation; and
means interconnecting the filter and the noise estimation module for iterating through the modules using the estimated standard deviation previously obtained from the noise estimation module to perform the filtering in the spatiotemporal filtering module until the value of the noise level approaches the unknown noise, whereby the noise level is then characterized by a finally determined standard deviation.

11. A spatiotemporal filter for reducing noise in an input video sequence without using a reference video indicative of a ground truth value, wherein the spatiotemporal filter uses the finally determined standard deviation produced by the system of claim 10.
